(19) United States
(12) Patent Application Publication
(10) Pub. No.: US 2007/0164623 A1
(43) Pub. Date: Jul. 19, 2007

(54) Housing assembly for a medium voltage solid-state reduced voltage starter

(75) Inventors: Alfred Lee Randall, Horse Shoe, NC (US); Lawrence Brown Farr, Asheville, NC (US); Joe Michael Kellis, Weaverville, NC (US)

Correspondence Address: Martni J. Moran;Eaton Electrical, Inc., Technology & Quality Center, 170 Industry Drive, RIDC Park West, Pittsburgh, PA, 15275-1032, US

(73) Assignee: Eaton Corporation

(21) Appl. No.: 11/333,001

(22) Filed: Jan. 17, 2006

(51) Int. Cl. H02K 5/00

(52) U.S. Cl. 310/89

(57) ABSTRACT

The present invention provides a single housing assembly for a reduced voltage motor starter assembly. The housing assembly has a medium voltage compartment and a low voltage compartment. In this configuration the housing assembly ins structured to enclose both the medium voltage portion and the low voltage portion of the starter assembly.

### BACKGROUND OF THE INVENTION

1. Field of the Invention

The present invention relates to a medium voltage solid-state reduced voltage starter and, more specifically, to a single housing assembly for a medium voltage solid-state reduced voltage starter.

2. Background Information

Electrical motors typically require a starter assembly structured to bring the motor up to an operating speed. Formerly, starter assemblies utilized air-break switches and vacuum contactors which evolved into, or were replaced by, solid state starter assemblies. The typical solid state starter assembly includes a low voltage portion, which is in electrical communication with the motor, and a medium voltage portion, which is in electrical communication with a power source. Such starter assemblies were either permanently coupled to the motor or a portable floor mounted starter assembly. This invention relates to starter assemblies which are permanently coupled to the motor.

In the prior art, the low voltage portion was enclosed by a first housing assembly and the medium voltage portion was enclosed by a second housing assembly. Both housing assemblies were mounted on the motor or the use device. That is, the motor typically provided power to a powered device which was part of a larger use device, such as, but not limited to, a chiller. The chiller, or other use device, had a body to which the motor, the powered device, the low voltage portion housing assembly, and the medium voltage portion housing assembly were attached. In this configuration, the starter assembly housing assemblies required multiple installation procedures and required an external cable to connect the low voltage portion and the medium voltage portion.

There is, therefore, a need for a single housing assembly for a starter assembly that is structured to enclose both the low voltage portion and the medium voltage portion.

There is a further need for a single housing assembly for a starter assembly that is structured to enclose both the low voltage portion and the medium voltage portion that is structured to be mounted on the starter motor or the associated use device.

### SUMMARY OF THE INVENTION

These needs, and others, are met by the present invention which provides a single housing assembly having a medium voltage compartment and a low voltage compartment. In this configuration the housing assembly is structured to enclose both the medium voltage portion and the low voltage portion of the starter assembly. In a preferred embodiment, the housing assembly includes a barrier assembly that defines the enclosed space. The barrier assembly includes a generally rectangular sidewall assembly which is coupled to a generally planar top member and a generally planar bottom member. The bottom member typically includes a mounting assembly structured to couple the housing assembly to the motor and/or the use device. The housing assembly includes a line opening adjacent to the medium voltage portion and a load opening adjacent to the low voltage portion. The connection between the medium voltage portion and a low voltage portion is within the housing assembly.

### BRIEF DESCRIPTION OF THE DRAWINGS

A full understanding of the invention can be gained from the following description of the preferred embodiments when read in conjunction with the accompanying drawings in which:

FIG. 1 is an isometric front view of a housing assembly for a reduced voltage motor starter coupled to a motor and disposed on a use device.

FIG. 2 is an isometric back view of a housing assembly for a reduced voltage motor starter coupled to a motor and disposed on a use device.

FIG. 3 is a top view of the housing assembly for a reduced voltage motor starter.

### DESCRIPTION OF THE PREFERRED EMBODIMENTS

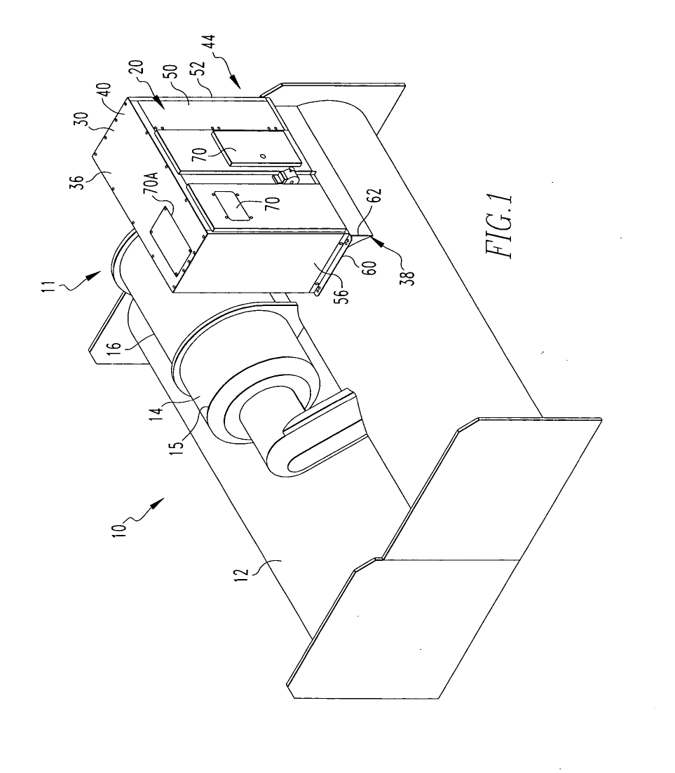

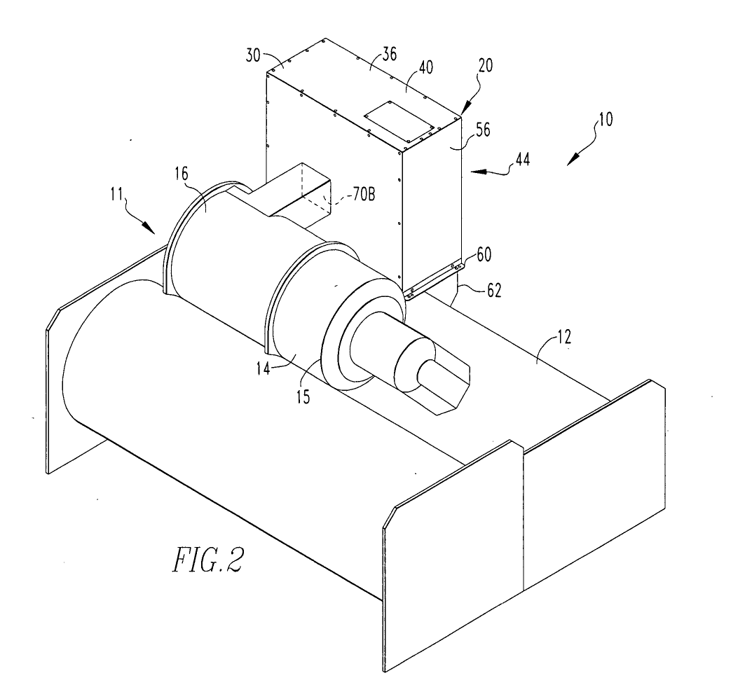

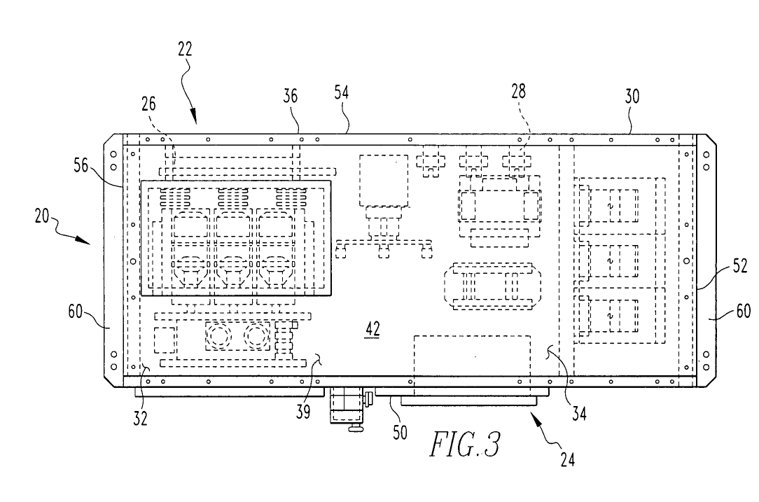

As shown in FIGS. 1 and 2, a use device 10, as shown, a chiller 11, includes a body 12, a powered device 14, as shown, a compressor 15, a motor 16 and a reduced voltage motor starter assembly 20. As shown in FIG. 3, the motor starter assembly 20 includes a plurality of medium voltage components 22, a plurality of low voltage components 24, and a housing assembly 30. The medium voltage components 22 preferably include, but are not limited to, one or more line terminals 26, which are structured to be coupled to a power source (not shown), an isolating switch, fuses, and contactors. The plurality of low voltage components 24 preferably include, but are not limited to, a transformer, a solid state control module, and the motor contactor(s) or load terminal(s) 28. The medium voltage components 22 and the low voltage components 24 are coupled together, and in electrical communication, via one or more internal conductors. The housing assembly 30 includes a medium voltage compartment 32 and a low voltage compartment 34. The medium voltage components 22 are, generally, disposed in the medium voltage compartment 32 and the low voltage components 24 are, generally, disposed in the low voltage compartment 34.

The housing assembly 30 includes a barrier assembly 36 and may include a mounting assembly 38. The barrier assembly 36 is structured to define an enclosed space 39 that is divided into the medium voltage compartment 32 and a low voltage compartment 34. While the barrier assembly 36 may be shaped as required for a particular use device 10, the barrier assembly 36 typically has a generally planar top member 40, a generally planar bottom member 42 and a sidewall assembly 44. The top member 40 and the bottom member 42 are maintained in a spaced, generally parallel configuration by the sidewall assembly 44. That is, the sidewall assembly 44 extends between, and generally perpendicular to, both the top member 40 and the bottom member 42. In the preferred embodiment, the sidewall assembly 44 includes four generally planar sidewall sections, a first section 50, a second section 52, a third section 54 and a fourth section 56. The first section 50 and the third section 54 are disposed in a spaced and generally parallel configuration. The second section 52 and the fourth section 56 are also disposed in a spaced and generally parallel configuration. Additionally, the first section 50 and the second section 52 are generally perpendicular to each other. Thus, in the preferred embodiment, the barrier assembly 36 is a generally rectangular box-like assembly.

As shown in FIG. 1, the housing assembly 30 may include a mounting device 38. The mounting assembly 38 is structured to support the entire motor starter assembly 20. The mounting device 38 is further structured to couple the housing assembly 30 to the use device 10. Thus, where the mounting assembly 38 is coupled to a flat surface, the mounting assembly 38 may simply include at least one flange 60. Where, however, the use device body 12 does not have a generally flat surface to which the entire motor starter assembly 20 may be coupled, the mounting assembly 38 may include at least one support member 62 such as, but not limited to, legs 64.

In this configuration, the housing assembly 30 may be mounted on the use device 10 while enclosing all of the medium voltage components 22 and low voltage components 24. As such, the medium voltage components 22 and low voltage components 24 may be coupled to each other without an external coupling device, such as, but not limited to, and external cable. Further, the total space or volume of a single housing assembly 30 is less than the combined space or volume of the separate medium voltage housing and low voltage housings. Preferably, the housing assembly 30 is sized to be about fifty-two inches high, fifty-nine inches wide, and twenty-five and a half inches deep. The cost and time for assembling the single housing assembly 30 is less than the cost of assembling a separate medium voltage housing and low voltage housing. For example, where there are multiple housing assemblies 30, each medium voltage and low voltage housing assembly must have various openings, removable sections and replaceable doors, collectively hereinafter “access panels,” each of which incur a manufacturing cost as well as requiring additional hardware. Where there is a single housing assembly 30, the number of access panels 70 may be reduced. For example, there is a line side access panel 70A, structured to allow line conductors (not shown) to be coupled to the line terminals 26, and a load terminal access panel 70B structured to allow the load terminals 28 to be coupled to the motor line conductors (not shown). However, if there were separate medium voltage and low voltage housing assemblies, the medium voltage housing assembly would need, for example, a conductor outlet access panel for a conductor coupling the medium voltage and low voltage components 22, 24. Preferably, the housing assembly 30 has only three access panels 70.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of invention which is to be given the full breadth of the claims appended and any and all equivalents thereof.

What is claimed is:

1. A housing assembly for a reduced voltage motor starter assembly, said reduced voltage motor starter assembly having a plurality of medium voltage components and a plurality of low voltage components, said housing assembly comprising a barrier assembly defining an enclosed space, said enclosed space structured to accommodate said medium voltage components and said low voltage components of said motor starter assembly.

2. The housing assembly of claim 1 wherein:
said barrier assembly includes a generally planar top member, a sidewall assembly and a generally planar bottom member;
said top member coupled to said sidewall assembly, said top member extending generally at a right angle to said sidewall assembly; and
said bottom member coupled to said sidewall assembly, said bottom member extending generally at a right angle to said sidewall assembly.

3. The housing assembly of claim 2 wherein:
said sidewall assembly includes four generally planar sidewall sections, a first section, a second section, a third section and a fourth section;
said first section and said third section being disposed in a spaced and generally parallel configuration;
said second section and said fourth section being disposed in a spaced and generally parallel configuration; and
said first section and said second section being generally perpendicular to each other.

4. The housing assembly of claim 2 wherein said bottom member includes a mounting assembly.

5. The housing assembly of claim 4 wherein said mounting assembly includes at least one flange.

6. The housing assembly of claim 4 wherein said mounting assembly includes at least one support member.

7. The housing assembly of claim 2 wherein:
said enclosed space includes a medium voltage compartment and a low voltage compartment;
said medium voltage compartment structured to enclose said reduced voltage motor starter medium voltage components; and
said low voltage compartment structured to enclose said reduced voltage motor starter low voltage components.

8. A reduced voltage motor starter assembly comprising:
a plurality of medium voltage components;
a plurality of low voltage components; and
a housing assembly having a barrier assembly defining an enclosed space, said enclosed space structured to accommodate said medium voltage components and said low voltage components of said motor starter assembly.

9. The reduced voltage motor starter assembly of claim 7 wherein:
said barrier assembly includes a generally planar top member, a sidewall assembly and a generally planar bottom member;
said top member coupled to said sidewall assembly, said top member extending generally at a right angle to said sidewall assembly; and
said bottom member coupled to said sidewall assembly, said bottom member extending generally at a right angle to said sidewall assembly.

10. The reduced voltage motor starter assembly of claim 9 wherein:
said sidewall assembly includes four generally planar sidewall sections, a first section, a second section, a third section and a fourth section;
said first section and said third section being disposed in a spaced and generally parallel configuration;
said second section and said fourth section being disposed in a spaced and generally parallel configuration; and
said first section and said second section being generally perpendicular to each other.

11. The reduced voltage motor starter assembly of claim 9 wherein said bottom member includes a mounting assembly.

12. The reduced voltage motor starter assembly of claim 1 wherein said mounting assembly includes at least one flange.

13. The reduced voltage motor starter assembly of claim 11 wherein said mounting assembly includes at least one support member.

14. The reduced voltage motor starter assembly of claim 9 wherein:
said enclosed space includes a medium voltage compartment and a low voltage compartment;
said medium voltage compartment structured to enclose said reduced voltage motor starter medium voltage components; and
said low voltage compartment structured to enclose said reduced voltage motor starter low voltage components.

15. The reduced voltage motor starter assembly of claim 9 wherein said medium voltage components and said low voltage components are coupled together by an internal conductor.

16. The reduced voltage motor starter assembly of claim 9 wherein said medium voltage components and said low voltage components are coupled to each other without an external coupling device.
